(19) United States
(12) Patent Application Publication
(10) Pub. No.: US 2019/0067648 A1
(43) Pub. Date: Feb. 28, 2019

(54) BATTERY CELL WITH ALUMINIUM CASE

(71) Applicant: NIO USA, Inc., San Jose, CA (US)

(72) Inventors: Austin L. Newman, San Jose, CA (US); Alexander J. Smith, White Lake, MI (US); Adam H. Ing, Santa Clara, CA (US); Rick Rajaie, Rochester Hill, MI (US)

(21) Appl. No.: 15/692,723

(22) Filed: Aug. 31, 2017

(51) Int. Cl. H01M 2/02; C23C 2/04; H01M 2/30; H01M 2/26; H01M 2/32; B23K 11/11; B23K 20/12

(52) U.S. Cl. CPC H01M 2/0262; C23C 2/04; H01M 2/30; H01M 2/0285; H01M 2220/20; H01M 2/32; B23K 11/11; B23K 20/129; H01M 2/26

(57) ABSTRACT

Methods and systems provide for the manufacture of a cylindrical battery cell case that is changed from steel (or nickel-plated steel) to aluminum. With this change, spot welding the copper tab from the anode to the aluminum case will result in the copper and aluminum corroding over time—leading to early battery failure. To manufacture the battery with the aluminum case, one or more manufacturing changes are made including one or more of: 1. changing the polarity of the battery to spot weld the copper tab to a steel top of the battery; 2. coating the copper tab with a second material to prevent corrosion; and/or, 3. use a different welding method (e.g., a friction stir weld) to fuse the copper tab to the aluminum case.

### FIELD

The present disclosure is generally directed to battery module construction, and more particularly to battery cell construction.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

Vehicles employing at least one electric motor and power system store electrical energy in a number of battery cells. These battery cells are typically connected to an electrical control system to provide a desired available voltage, ampere-hour, and/or other electrical characteristics. Advances in battery technology have resulted in the increasing use of large batteries, comprising tens, hundreds, or even thousands of individual cells, for applications such as powering various electrical components of vehicles (including vehicles designed for travel over land and water and through the air) and storing electricity generated using renewable energy sources (e.g. solar panels, wind turbines).

As the battery modules used in the electric vehicles (EVs) are made primarily of metals, largely steel, the battery modules are heavy. Thus, the power source (e.g., the battery modules themselves) of the EVs comprises one of the heaviest components in the EV. There is a need to reduce the weight of the battery modules to make the EV propulsion system more efficient.

### BRIEF DESCRIPTION OF THE DRAWINGS

FIG. 1A is a perspective view of a battery cell in accordance with embodiments of the present disclosure;

FIG. 1B is a perspective view of a weldable battery cell in accordance with embodiments of the present disclosure;

FIG. 1C is an internal view of the battery showing the inner construction of the battery in accordance with embodiments of the present disclosure;

FIG. 2A is a detail partial section view showing a first battery cell anode tab welding to a first case section in accordance with embodiments of the present disclosure;

FIG. 2B is a second detail partial section view showing a first battery cell anode tab welding to a first case section in accordance with embodiments of the present disclosure;

FIG. 3 is a block diagram of a friction stir welding system in accordance with embodiments of the present disclosure embodiment;

FIG. 4 shows a perspective view of a configuration of materials for an anode tab in accordance with embodiments of the present disclosure;

FIG. 5A shows a configuration of materials for an anode tab in accordance with embodiments of the present disclosure;

FIG. 5B shows a configuration of materials for an anode tab in accordance with embodiments of the present disclosure;

FIG. 6 provides a flowchart for a method of creating a battery with an aluminum case in accordance with embodiments of the present disclosure;

FIG. 7 provides a flowchart for a method of creating a battery with an aluminum case in accordance with embodiments of the present disclosure;

FIG. 8 provides a flowchart for a method of creating a battery with an aluminum case in accordance with embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Cylindrical batteries generally have cases made from steel. Embodiments herein include battery cells where the case is made from aluminum rather than steel. Batteries with aluminum cases have numerous advantages including lower mass (EVs can contain thousands of cylindrical cells, and even small mass savings with each cell can equate to hundreds of pounds weight savings for the EV), better thermal conductivity (aluminum is nearly a four (4) times better conductor of hear compared to steel, and better electrical conductivity. Thus, batteries with an aluminum cases are lighter (allowing the EV to travel longer distances on the same charge), requires less active cooling energy (again allowing the EV to travel longer distances on the same charge), and more efficiently conducts the charge to the power system (yet again the EV to travel longer distances on the same charge).

Battery technology (energy density) typically improves at a rate of 2.5-5% per year in the industry even with millions of dollars spent on bringing each small variation of the battery or other device into production. Changing the case material from steel to an aluminum may potentially improve battery cell energy density by 5-10%.

To allow for an aluminum case, some manufacturing and battery cell designs may need to change. Generally, the positive terminal of the battery cell is on top of battery “can” (referred to as a “nub”); the negative terminal on the battery cell is the rest of the can (the case). The negative terminal (or anode) can be welded to a copper tab (jellyroll). The copper tab may then be welded to the can, which in prior batteries was generally nickel-plated steel. The positive (or cathode) can be attached to an aluminum tab that may be currently attached to the top of the battery (or “button”) by a spot weld.

In the embodiments described herein, cylindrical battery cell case is changed from steel (or nickel-plated steel) to aluminum. With this change, spot welding the copper tab from the anode to the aluminum case will result in the copper and aluminum corroding over time—leading to early battery failure. With the change to an aluminum case, attachment of the copper tab and other challenges may be necessitated.

Some of the design changes that may be made include: 1. Changing the polarity of the battery; 2. Coating the copper tab to prevent corrosion; and, 3. Use a different welding method (e.g., a friction stir weld) to attach the copper tab to the aluminum case. To change the polarity, the inside lamination of the anode and cathode (the “jellyroll”) can be inserted 180° from the typical orientation. Then, the copper tab can be spot welded to the top cap or button. The top cap or button becomes the negative or ground terminal. The aluminum tab from the cathode can then be welded directly to the aluminum case in an aluminum to aluminum bond. Thus, the possibility of corrosion is eliminated, but the polarity of the battery cell is opposite of typical batteries.

In another configuration, the polarity is retained but the copper tab is coated with a material that will prevent corrosion when the anode tab is welded to the aluminum case. For example, the copper tab may be coated with nickel plating, which does not react with the copper of aluminum and prevent corrosion. Another plating or coating may also be possible.

Finally, the type of weld between the copper tab and the aluminum case may be changed. Spot welding allows for the materials to corroded. However, another type of weld, e.g., a friction stir weld, can fuse weld the materials together to prevent oxidation/corrosion. A fuse weld mixes the materials into a matrix eliminating or preventing galvanic or other corrosive reactions.

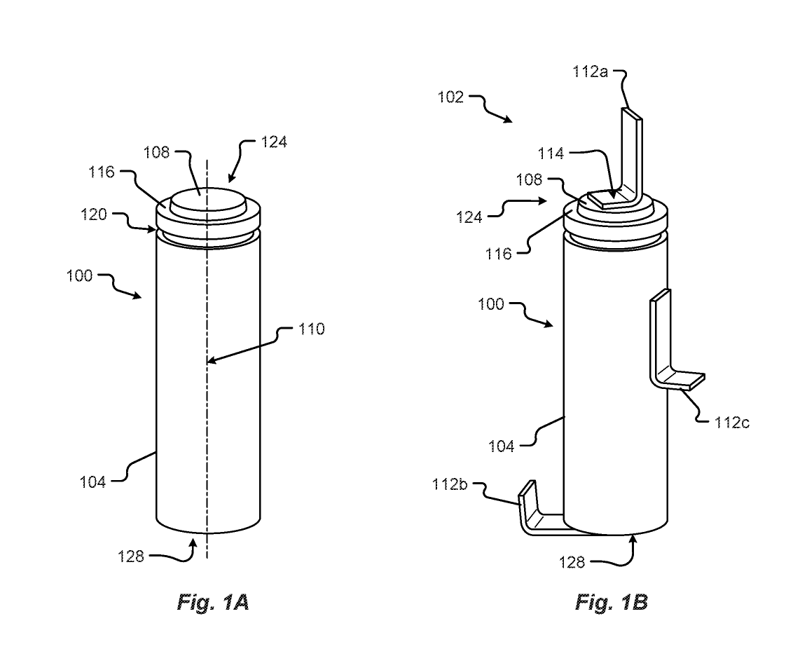

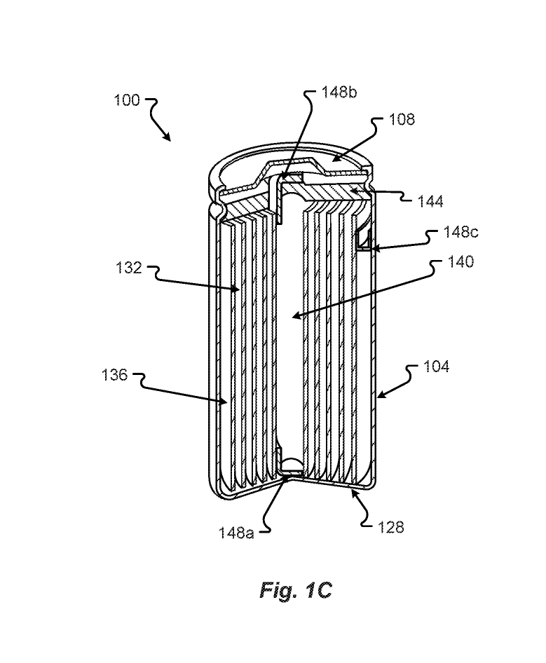

Referring now to FIG. 1, a perspective view of a battery cell 100 is shown in accordance with embodiments of the present disclosure. The battery cell 100 may comprise a body 104 (e.g., the case), a top portion 124 (e.g., the top cap), a bottom portion 128, and a first terminal 108 (e.g., the button), and a second terminal, which may be the entire case 104 but is generally considered on the bottom of the battery cell 100 (not visible). In some configurations, the first terminal 108 may correspond to a positive terminal (the cathode) disposed at the top portion 124 of the battery cell 100. In some configurations, the second terminal may correspond to the negative terminal (the anode). However, this arrangement of the positive and negative terminals may switch, as explained hereinafter. The second terminal may be disposed opposite the positive terminal (e.g., at the bottom portion 128 of the battery cell 100). In other configurations, the second terminal may be disposed on a side of the battery cell 100 other than the bottom portion 128. Herein, the body 104 may be made from aluminum, as opposed to steel, nickel-plated steel, or other metal or substance heavier than aluminum. The top portion 124 may be made from steel or a plated-steel formation.

The first terminal 108 may be insulated from the second terminal, or other part of the battery cell 100, via an insulation area 116. The insulation area 116 may be configured to electrically isolate the first terminal 108 from the second terminal, body 104, or other part of the battery cell 100. In some configurations, the insulation area 116 may be made from a plastic, cardboard, paper, linen, composite, or other non-conductive material.

In at least one configuration, the battery cell 100 may be substantially cylindrical in shape. Additionally or alternatively, the battery cell 100 may be symmetrical about at least one axis. For example, the battery cell 100 may be substantially symmetrical about a center axis 100 running from the top portion 124 to the bottom portion 128. The battery cell 100 may include one or more manufacturing features 120 including, but in no way limited to, indentations, alignment marks, reference datum, location features, tooling marks, orientation features, etc., and/or the like. As shown in FIG. 1A, the manufacturing feature 120 of the battery cell 100 may be a rolled, or sealed, portion of the battery cell 100 (e.g., disposed near a top portion 124 of the battery cell 100).

In any event, the battery cell 100 may be configured to store energy via one more chemicals contained inside the body 104. In some configurations, the battery cell 100 may be rechargeable and may include one or more chemical compositions, arrangements, or materials, such as, lithium-ion, lead-acid, aluminum-ion, nickel-cadmium, nickel metal hydride, nickel-iron, nickel-zinc, magnesium-ion, etc., and/or combinations thereof. The positive terminal of the battery cell 100 may correspond to the cathode and the negative terminal may correspond to the anode. When connected to a busbar or other connection, current from the battery cell 100 may be configured to flow from the terminals of the battery cell 100 through the busbar to one or more components of an electric power distribution system. This current flow may provide power to one or more electrical elements associated with an electric vehicle.

FIG. 1B shows another perspective view of a weldable battery cell 100 including a terminal tab 112a connected to the first terminal 108 or a second terminal tab 112b, 112c connected to a second terminal 128. The terminal tab 112 may be connected to a busbar that extends between adjacent battery cells 100 in a battery module. In other configurations, the terminal tab 112 represents a portion of the busbar, where the other portions of the busbar are not shown. Regardless, the following description can be adapted to other types of busbars.

The terminal tab 112a is shown attached to the first terminal 108 at a first attachment point 114. In some configurations, the attachment may include welding, brazing, or soldering the terminal tab 112a to the first terminal 108 of the battery cell 100. Although shown as connected at the top 124 of the battery cell 100, the terminal tab 112 may be connected to different ends, portions, or areas, or parts of the battery cell 100 that are separated by at least one insulation area 116. In at least some configurations, the terminal tab 112a may be made from a conductive material or coating including, but in no way limited to, copper, aluminum, gold, silver, platinum, iron, zinc, nickel, etc., and/or combinations thereof.

The terminal tab 112b or 112c is shown attached to the second terminal 128 or case 104, respectively. In some configurations, the attachment may include welding, brazing, or soldering the terminal tab 112b, 112c to the second terminal 128 or case 104 of the battery cell 100. Although shown as connected at the bottom or side of the battery cell 100, the terminal tab 112b or 112c may be connected to different ends, portions, or areas, or parts of the battery cell 100. In at least some configurations, the terminal tab 112b or 112c may be made from aluminum, plated-copper or other material that does not cause corrosion of the terminal tab 112b or 112c or the aluminum case 104.

In some configurations, the terminal tab 112 may be configured as a flat solid metal connector. The flat solid metal connector may be bent along an unattached portion of a planar surface of the tab 112 and configured to extend from at least one surface of the weldable battery cell 100.

An example of a cross section of the battery cell 100 may be as shown in FIG. 1C. The battery cell 100 can be any type of battery such as a lithium ion battery, nickel-metal hydride, etc., as described above. The cathode and anode may be formed in sheets 132, 136, separated by material, then wrapped around a central core 140. The battery 100 can have top cap 108, which may form a first terminal, and a second terminal which may be formed from the body 104 of the battery of the battery 100. A top vent 144 may be formed in the top 116 to allow explosive/expansive gases to be exhausted from the battery core. To enable the more efficient use of the battery 100, the battery 100 may need to be cooled in some configurations or situations.

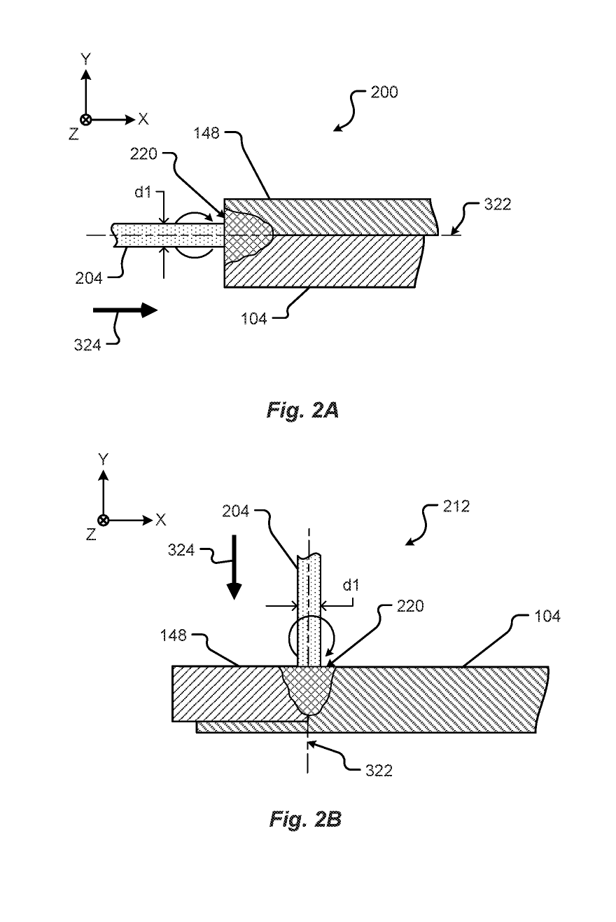

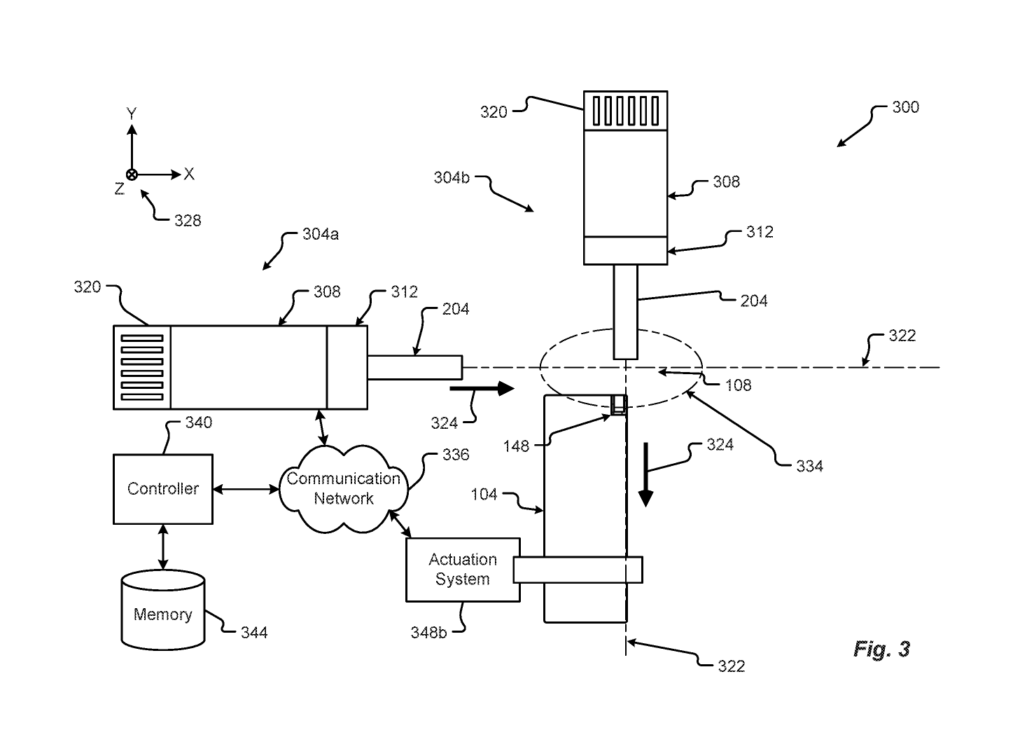

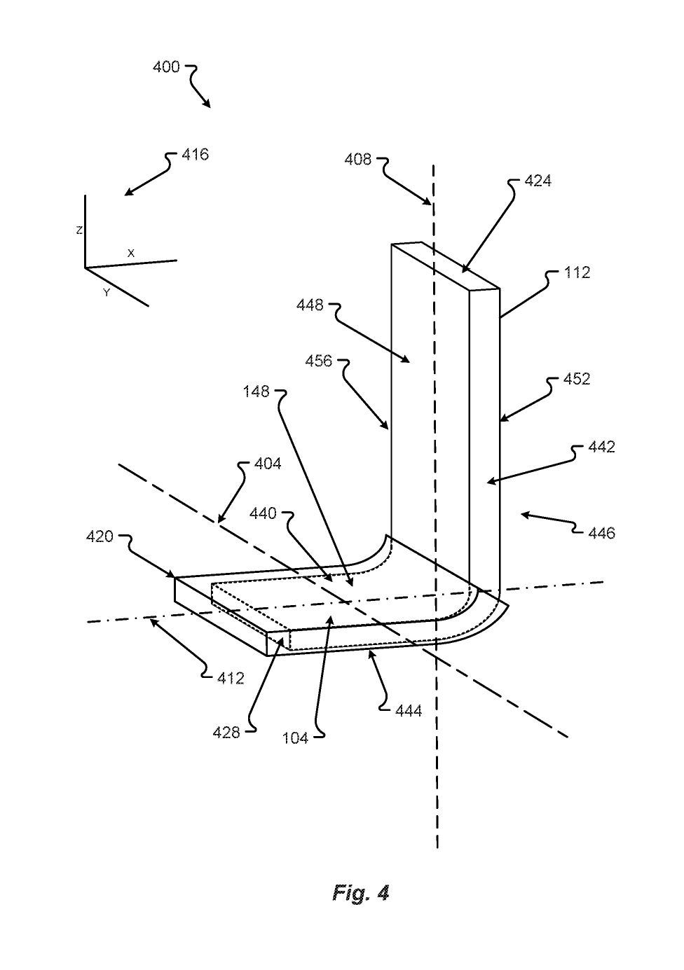

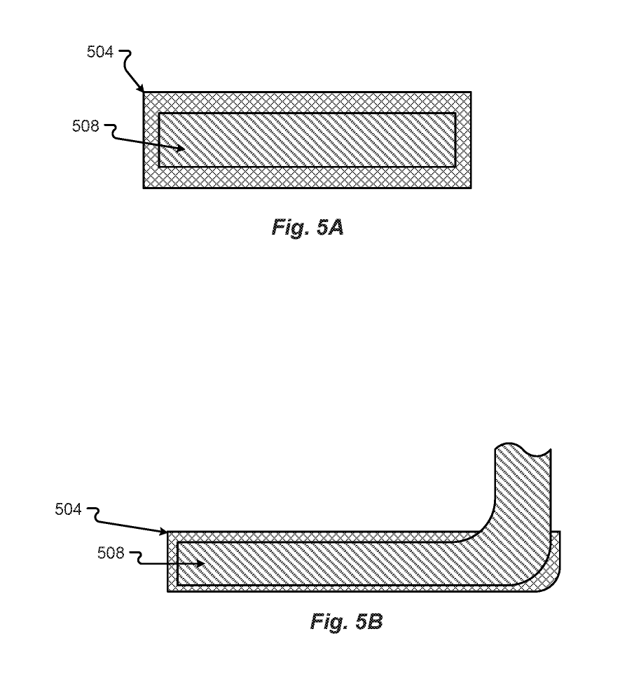

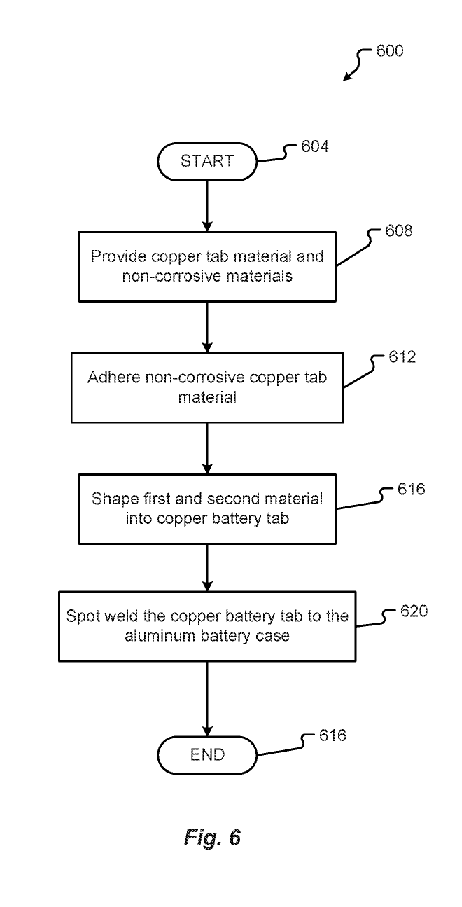

To connect the cathode to either the body 104 or the top cap 108, a tab 152 may extend from a portion of one of the sheets 132. The tab 152 can be welded, adhered, attached, etc. to the body 104 or top cap 108. Similarly, to connect the anode to either the body 104 or the top cap 108, a tab 148 may extend from a portion of one of the sheets 136. The tab 148 can also be welded, adhered, attached, etc. to the body 104 or top cap 108. If the cathode, sheet 132, is attached to the top cap 108, then the anode, sheet 136 is attached to the body 104 or vice versa. Thus, the anode and cathode are not both attached to the top cap 108 or body 104. If the tabs 148 or 152 are copper, then the tab 148, 152 may be attached to the top cap 108, which may be steel or plated-steel. The tab 148, 152 attached to the aluminum body 104 is also aluminum, a non-corrosive metal or conductor, or copper coated with a material or plating, as described in conjunction with FIGS. 4A and 4B. In still another configuration, the tab 148, 152 attached to the aluminum body 104 may also be fused to the aluminum body 104 through friction stir welding, as described in conjunction with FIGS. 2A through 3, or other process. The fusing of the copper tab 148, 152 to the aluminum can form a matrix of the two materials that prevents or eliminates corrosion and/or oxidation. An alternative position for the copper tab 148b may be along a side of the case 104 to allow for the copper tab 148 to be friction stir welded to the case 104, using the tooling and welds described in FIGS. 2A through 3.

In one configuration, the anode is the negative terminal and has a copper tab 148 extending from the sheet 136. Typically, the copper tab 148 is attached to the bottom of the case 104. However, in this configuration, the inner formation of the sheets 132, 136 is flipped or rotated around axis 156 where the copper tab 148 is in physical proximity to the top cap 108 instead of the bottom of the case 104. Then, the copper tab 148 is spot welded to the steel top cap 108 instead of the aluminum body 104. The aluminum tab 152 of the cathode sheet 132 is likewise spot welded to the bottom portion of the aluminum case 104. This configuration prevents corrosion as the copper tab 148 is not attached to the aluminum case 104 but the aluminum tab 152 is attached to the aluminum case 104. However, the polarity of the battery 100 is reversed. The top cap 108 becomes the negative terminal and the case 104 becomes the positive terminal.

FIGS. 2A-2B show section views illustrating a first and second fusion operation 200, 212 of the copper tab 148 to the aluminum case 104 in accordance with embodiments of the present disclosure. In embodiments, the copper material of the copper tab 148 is fused with the aluminum case material 104 with a friction stir weld using tooling 204 that fuses the material along a joint line 322. The rotating tooling is positioned in a direction 324 perpendicular to the tool's contact area with the joint between the copper tab 148 and the case material 104. The first configuration 200 shows that the copper tab 148 and terminal 108 are disposed in the same plane and with the edge junction between the copper tab 148 and a raised portion of the case in a line with the tooling orientation 322.

Referring to FIG. 2A, the tooling 204 is shown directed toward the copper tab 148 and case 104 in a direction 324. The tooling 204 rotates around an axis 322 through the center of the cylindrical tooling with the axis 322 being substantially centered on the joint between the copper tab 148 and the case material 104. The tooling 204 can have a first diameter, dl, at the first friction stir weld area 220. Upon contacting the copper tab 148 and case 104, the tooling 204 rapidly spins to heat, through friction, the material of the copper tab 148 and case 104. The heat generated by the tooling 204 causes the material of both the copper tab 148 and case 104 to melt and stir together. This interaction between the melted materials at the copper tab 148 and case 104 causes the materials to combine and join to one another, in other words, fuse together. In some configurations, the diameter, dl, of the tooling 204 may define the size and formation of the penetration of the friction stir weld at the first welding area 220. As shown in FIG. 2A, the penetration of the weld is shown gradually tapering from a first size to a reduced second size in direction 324. The mixing of the materials can prevent or eliminate corrosion between the copper in the copper tab 148 and the aluminum in the case 104.

FIG. 2B shows a view of tooling 204 configured to friction stir weld the copper tab 148 and case 104 along a face of copper tab 148 and case material 104. The tooling 204 passes, at least partially, along a face of the copper tab 148 and the case 104. Upon touching or contacting the joint between the copper tab 148 and the case 104, the spinning tooling 204 rapidly heats the material of the cell case 104 and the material of the copper tab 148. The heat generated by the focused friction stir weld beam 204 causes the material of both the copper tab 148 and case 104 to melt and stir together. Similar to the first weld shown in FIG. 2A, this interaction between the melted materials at the second welding area 220, shown in FIG. 2B, causes the copper tab 148 and case 104 to combine and join to one another.

FIG. 3 is a schematic diagram of a friction stir welding system 300 in accordance with embodiments of the present disclosure embodiment. The friction stir welding system 300 may include a friction stir welder 304a/304b comprising a friction stir weld motor 308, tooling 204, and a power supply 320. The friction stir welder 304 may be configured to convert electrical energy provided via the power supply 320 to generate a high-speed rotation of the tooling 204.

In some configurations, the friction stir welder 304 may be configured to move the tooling along direction 324 to contact the joint between the copper tab 148 and the aluminum case 104. The path of the tooling 204 may follow a substantially linear path defined by line 322. This linear path 322 defines the location of the weld areas for the copper tab 148 to the case 104.

Prior to friction stir welding, the weldable battery cell case 104 may be positioned into contact with the copper tab 148 via a force that causes contact between the copper tab 148 and the case 104. The position of the weldable battery cell case 104 may be held in place by one or more end-effectors, clamps, fixtures, tools, etc., and/or the like. In some configurations, at least one position of the friction stir welder 304 may be fixed relative to the copper tab 148, the weldable battery cell 100, combinations thereof, and/or some other reference datum. For instance, the friction stir welder 304 may be fixed in the Y-axis direction and/or X-axis direction (shown as the vertical and/or horizontal direction of the coordinate system 328 of FIG. 3) at a distance offset from the joint between the copper tab 148 and the case 104. The offset distance may be used to define the location or depth of the friction stir weld. As provided above, the tooling may be moved to contact the joint area between the copper tab 148 and the case and then rotated at high speed to cause heat by friction and stir material together in an area defined within a region of abutted material.

In some configurations, two or more weldable battery cells 100 may be disposed side-by-side. As shown in FIG. 3, the coordinate system 328 defines an X-axis running in a horizontal direction, a Y-axis running in a vertical direction, and a Z-axis running in a direction orthogonal and perpendicular to the X-Y plane shown (e.g., into and/or out of the page). It is anticipated that the two or more weldable battery cells 100 may be disposed side-by-side in the Z-axis direction. The arrangement of cells 100 along a length and in the Z-axis direction can allow the friction stir welder 304 to stay fixed in the X-axis and/or Y-axis direction, align with the tooling 204 with the joint between the copper tab 148 and the case 104, move the tooling 204 in contact with the joint, perform the friction stir welding described herein, and index along the Z-axis direction to the joint of a second cell. Additionally or alternatively, the position of the friction stir welder 304 may remain fixed in the X-axis and/or Y-axis direction while moving to subsequent cells 100 disposed along a length in the Z-axis direction.

As can be appreciated, the above example describes moving the friction stir welder 304 relative to the weldable battery cells 100. However, the present disclosure is not so limited. For instance, the friction stir welder 304 may remain fixed in all axes (e.g., the X-axis, Y-axis, and Z-axis) and the weldable battery cells 100 may move to contact the tooling 204. It should be appreciated that the friction stir welder 304 can be positioned in other positions to perform the friction stir welds. In other words, once the friction stir welder 304 is positioned to completely weld the weldable battery cell case 104 to the copper tab 148, the friction stir welder 304 is not moved to the other side. This single-position for the friction stir welder 304 on one side of the copper tab 148 and weldable battery cell case 104 to perform multiple welds sequentially allows for fewer setups than compared with traditional welding operations. As provided above, traditional welding operations require the repositioning of a welder to complete all the connection welds for a single battery cell. This repositioning requires multiple setups to a welding system to weld a battery cell 100. The present disclosure describes making one setup to the position of the friction stir welder 304 to make welds required to completely attach the weldable battery cell case 104 to the copper tab 148.

The movement, indexing, alignment, positioning, and/or orientation of one or more components of the friction stir welding system 300 described above may be performed by at least one actuation system 348. The actuation system 348 may include one or more grippers, actuators, robots, slides, rails, clamps, position-feedback devices, sensors, mechanisms, machines, and/or the like, etc. The actuation system 348 may be configured to move one or more components of the system 300 including, but in no way limited to, the cell case 104, the copper tab 148, the friction stir welder 304, etc. In some configurations, the actuation system 348 and/or other components of the friction stir welding system 300 may receive instructions and/or commands from a controller 320.

One or more components of the friction stir welding system 300 (e.g., the friction stir welder 304, actuation system 348, etc.) may be operated, positioned, and/or otherwise controlled by a controller 320. The controller 320 may be a part of the friction stir welder 304 or located separately and apart from the friction stir welder 304. In any event, the controller 320 may include a processor and a memory 344. The memory 344 may be one or more disk drives, optical storage devices, solid-state storage devices such as a random-access memory (“RAM”) and/or a read-only memory (“ROM”), which can be programmable, flash-updateable, and/or the like. The controller/processor 320 may comprise a general purpose programmable processor or controller for executing application programming or instructions related to the friction stir welding system 300. Furthermore, the controller/processor 320 can perform operations for configuring and transmitting/receiving information as described herein. The controller/processor 320 may include multiple processor cores, and/or implement multiple virtual processors. Optionally, the controller/processor 320 may include multiple physical processors. By way of example, the controller/processor 320 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

Examples of the processors 320 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® CortexTMM processors, ARM® Cortex-A and ARM926EJ-S™ processors, other industry-equivalent processors, and may perform computational functions using any known or future-developed standard, instruction set, libraries, and/or architecture.

In accordance with at least some embodiments of the present disclosure, the communication network 336 may comprise any type of known communication medium or collection of communication media and may use any type of protocols, such as SIP, TCP/IP, SNA, IPX, AppleTalk, and the like, to transport messages between endpoints. The communication network 336 may include wired and/or wireless communication technologies. The Internet is an example of the communication network 336 that constitutes an Internet Protocol (IP) network consisting of many computers, computing networks, and other communication devices located all over the world, which are connected through many telephone systems and other means. Other examples of the communication network 336 include, without limitation, a standard Plain Old Telephone System (POTS), an Integrated Services Digital Network (ISDN), the Public Switched Telephone Network (PSTN), a Local Area Network (LAN), such as an Ethernet network, a Token-Ring network and/or the like, a Wide Area Network (WAN), a virtual network, including without limitation a virtual private network (“VPN”); the Internet, an intranet, an extranet, a cellular network, an infra-red network; a wireless network (e.g., a network operating under any of the IEEE 802.9 suite of protocols, the Bluetooth® protocol known in the art, and/or any other wireless protocol), and any other type of packet-switched or circuit-switched network known in the art and/or any combination of these and/or other networks. In addition, it can be appreciated that the communication network 336 need not be limited to any one network type, and instead may be comprised of a number of different networks and/or network types. The communication network 336 may comprise a number of different communication media such as coaxial cable, copper cable/wire, fiber-optic cable, antennas for transmitting/receiving wireless messages, and combinations thereof.

A copper tab 148 may be as shown in FIG. 4 in accordance with embodiments of the present disclosure. The copper tab 148 may be made from copper, and therefore susceptible to corrosion and/or oxidation, but may be coated in or adhered to a non-corrosive metal or other compound 420. For explanation of the non-corrosive portion of the tab 148, a description of the tab 148 may be as provided in FIG. 4 or above. First, a tab 148 may have a medial end 424 and a distal end 428. The tab 148 may also have a first side 432 and a second side 436. Further, the tab 148 may have a contact portion 104 that may have a top portion 440 and a bottom portion 444. The top portion 440 may relate to a first edge 448 on an upright portion 456 of the tab 148. The upright portion 456 may also have a second edge 452. The coating 420 may be on a portion of the tab 148. For example, as shown in FIG. 4, the coating 420 may only be on the contact portion 104. However, the coating 420 can be over the entire tab 148 or over some other portion.

Shown in FIG. 4, a three-dimensional coordinate system 416 is provided. As such, the figures that follow may be cross sections associated with planes dissecting the tab 148, for example a z,x plane dissecting the tab 148 along line 408. A dissection may also be along the z,y plane along line 404 or in the x,y plane along line 412. The different dissections may provide a cross section view of the coating or portions of the electrically conductive and/or magnetic materials.

Different configurations of different coatings or combinations of the copper of the copper tab 148 and a non-corrosive metal or other material on the copper tab 148 may be as shown in FIGS. 5A and 5B in accordance with embodiments of the present disclosure. A first configuration of a non-corrosive material 504 and copper tab material 508 may be as shown in FIG. 5A. The cross section of the copper tab 148 in FIG. 5A shows the non-corrosive material 504 coating or enveloping the copper tab material 508.

Another configuration that may be the same or similar to the configurations shown in FIG. 5A, with a non-corrosive material 504 enveloping the copper tab material 508, may be as shown in FIG. 5B. The configuration in FIG. 5B shows that the contact portion of the copper tab 148 may be the only portion of the copper tab 148 that is coated with the non-corrosive material 504.

Many different processes may be employed to combine the non-corrosive material 504 and the copper tab material 508. The different processes can include soldering, welding, brazing, forging, hot dipping, or other types of processes that can provide for the adherence, joining, or attachment of the non-corrosive material 504 and copper tab material 508. Further, there may be more configurations of the copper tab material 508 and the non-corrosive material 504 than those described in FIGS. 5A and 5B. Regardless, at least a portion of the copper tab 148 may be provided as a non-corrosive material 504 and a portion may be provided as copper material 508. In the configurations, the non-corrosive material 504 may not be as electrically conductive as material 508. However, the non-corrosive material 504 may have some electrically conductive properties to allow the copper tab 148 to be welded to the terminal 108 and conduct electricity through material 504.

In some configurations, the properties or chemical structure of copper tab material 508 may be changed to make the material 508 less susceptible to corrosion. For example, ions may be embedded in or removed from the copper tab material 508 to make the material 508 less susceptible to corrosion.

Possible non-corrosive materials 504 may be as discussed previously. For example, the non-corrosive material 504 may be neodymium, iron, nickel, cobalt, etc., or combinations thereof. The copper tab material 508 is generally copper. The combination of the two materials 504, 508 or the embedding of ions within the copper tab material 508 allows for the copper tab 148 to conduct electric current from the batteries 104 but prevent the copper from corroding or oxidizing yet allow the copper tab 148 to be soldered or welded to the aluminum case 104.

A method 600 for manufacturing a battery cell with an aluminum case may be as shown in FIG. 5 in accordance with embodiments of the present disclosure. Non-corrosive material 508 and copper tab material 504 are provided, in step 608. The material 508, 504 may be provided as bar stock, the copper tab material 508 may be provided as an anode tab 148, possibly attached to the anode of the battery lamination, as shown in FIG. 1C, ready to be hot dipped. In other situations, the materials 508, 504 may be provided with indentions or other types of configurations.

The materials 508, 504 may then be provided into a manufacturing assembly for adhering the non-corrosive material 504 to the copper material 508, in step 612. The adherence may be by dipping the copper material 508 into a container with molten non-corrosive material 504 to form the configurations as shown in FIGS. 4, 5A, and 5B. In other configurations, the non-corrosive material 504 and the copper tab material 508 may be welded, brazed, joined, etc. or may be attached through an adhesive or some other process to configure the tab 148, as shown in FIGS. 4, 5A, and 5B. There may be other methods or processes that adhere or join the second non-corrosive material 504 to the conductive copper material 508.

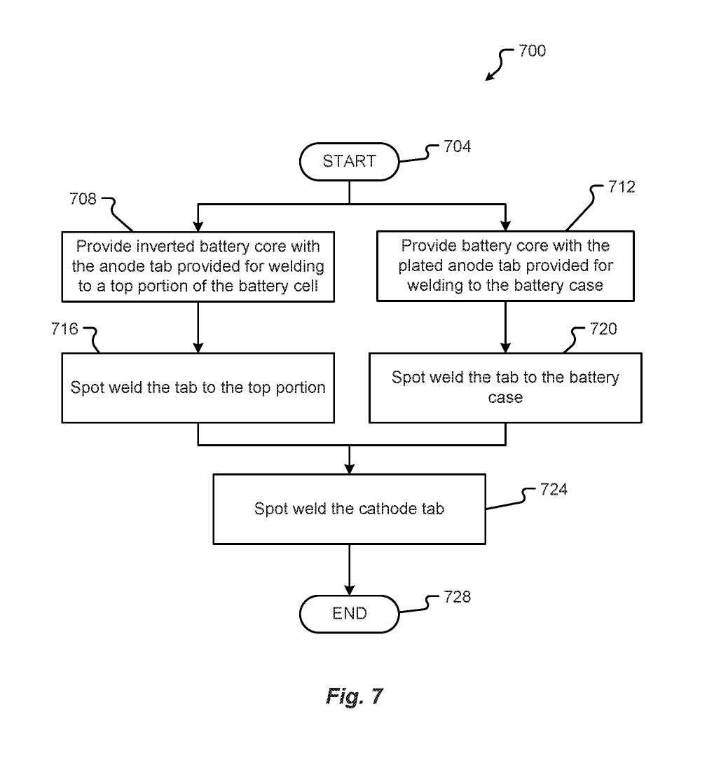

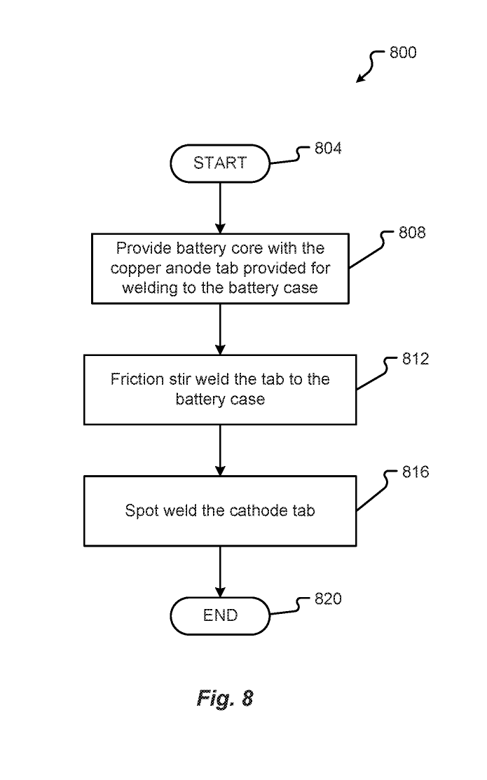

Optionally, the materials 508, 504 may be shaped into the tab 148 by bending or other processes to for the bent tab, as shown in FIG. 4, in step 616. In such a case, the tab material 148 may be shaped into the bent tab 148 to attach to the battery cell case 104, described hereinafter in FIG. 7. For example, the materials may be provided as a bar that is bent into the tab shape as shown in FIG. 4. In other situations, the material 504, 508 can be modified either by stretching, flattening, molding, or some other process that shapes the materials 508, 504 now attached, joined, adhered, etc. together into the “L-shape” of the tab 148, as shown in FIG. 4.

The shaped tab 148 may then be spot weld to the battery case 104, in step 620. The welding of the tab 148 may be as described in conjunction with FIG. 7.

A method 700 for manufacturing a battery cell with an aluminum case may be as shown in FIG. 7 in accordance with embodiments of the present disclosure. An anode tab 148 can be provided either in step 708 or step 712. If the anode tab 148 is copper and not plated, the tab 148 can be welded to the top portion 108 of the battery cell 100 to create a battery cell 100 with a reversed polarity, as described in FIGS. 1A-1C, and is provided in step 708.

If the anode tab 148 is copper and plated, the plated-copper tab can be spot welded to the aluminum case 104 and is provided in step 712. The non-plated copper anode tab 148 can then be spot welded to the top portion 108, in step 716. Spot welding is known and understood in the art and will not be explained further herein. In contrast, if the tab 148 is platted, the tab 148 can be spot welded to the battery case 104, in step 720. In step 720, the tab 148c may be positioned on a side of the battery case 104 as shown in FIG. 1C. This positioning makes the welding easier to perform.

In step 724, the cathode tab 152 is then spot welded. The cathode tab 152 is generally made from aluminum. As such, the cathode tab 152 can be spot welded to a steel top portion 108, if the plated-anode tab 148 is spot welded to the battery case 104. In contrast, if the anode tab 148 is welded to the top portion 108, the cathode tab 152 can be spot welded to the battery case 104. In this configuration, the aluminum tab 152 is spot welded to the aluminum case 104, eliminating or reducing possibilities for corrosion.

A method 800 for manufacturing a battery cell with an aluminum case may be as shown in FIG. 8 in accordance with embodiments of the present disclosure. An anode tab 148 can be provided in step 808. The copper anode tab 148 may not be plated but may need to be attached to the battery case 104. The tab 148 can be welded to the side of the battery cell 100 as shown in FIG. 1C.

The junction of the copper anode tab 148 and the aluminum battery case 104 may be provided to a friction stir welding system 300. The junction of the abutted joint can be aligned with the rotational axis 322 of the tooling 204. The tooling 204 may then be moved to contact the tab 148 and case 104 at the joint. The actuation system 348 can ensure the joint contacts the tooling 204. Upon correct placement of the tooling 204, the controller 340 can cause the activation of the motor 308 and powering of the motor 308 through the power supply 320. The motor 308 can then spin or rotate the tooling 204 at a high rate of speed on the joint of the tab 148 and case 104 causing friction and, thus, heat. The heat can melt the two materials, as explained in conjunction with FIGS. 2A-3, to mix the copper and aluminum together in a friction stir weld, in step 812. The matrix of metal 220 created by the friction stir weld help mitigate the possibility of corrosion or oxidation.

In step 816, the cathode tab 152 is then spot welded. The cathode tab 152 is generally made from aluminum. As such, the cathode tab 152 can be spot welded to a steel top portion 108.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the creation and manufacture of a battery cell with an aluminum case. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments of the present disclosure include a battery, comprising: a battery core including a lamination, the lamination comprising: an anode formed from a first sheet of a first material; a cathode formed from a second sheet of a second material; a first tab extending from the first sheet of material; a second tab extending from the second sheet of material; a top portion; and a case, wherein the case is made from aluminum.

Any of the one or more above aspects, wherein, wherein the first tab is made from copper.

Any of the one or more above aspects, wherein, wherein the second tab is made from aluminum.

Any of the one or more above aspects, wherein, wherein the first tab is plated in a non-corrosive material.

Any of the one or more above aspects, wherein, wherein the non-corrosive material is nickel.

Any of the one or more above aspects, wherein, wherein the plated first tab is spot welded to the case.

Any of the one or more above aspects, wherein, wherein the first tab is spot welded to the top portion.

Any of the one or more above aspects, wherein, wherein the top portion is a negative terminal of the battery.

Any of the one or more above aspects, wherein, wherein the copper of the first tab is mixed with the aluminum of the to the case.

Any of the one or more above aspects, wherein, wherein the copper of the first tab is mixed with the aluminum of the to the case by a friction stir weld.

Embodiments of the present disclosure include a welding method, comprising: providing an anode tab extending from an anode of a core of a cylindrical battery, wherein the anode tab is to be spot welded to a case of the cylindrical battery, wherein the battery case is made from aluminum, wherein the anode tab comprises a first material, wherein the first material is copper; plating the anode tab with a second material, wherein the second material is non-corrosive; providing the core comprising the anode tab; moving the anode tab or the battery case such that the anode tab is in physical proximity to the battery case; and when the anode tab is within physical proximity of the battery case, spot welding the anode tab to the battery case.

Any of the one or more above aspects, wherein, wherein the second material coats the first material by hot dipping the first material into a molten second material.

Any of the one or more above aspects, wherein, wherein the second material is joined to the first material by welding, brazing, hot dipping, and/or adhering.

Any of the one or more above aspects, wherein, wherein the second material is nickel.

Any of the one or more above aspects, wherein, wherein the second material is not corrosive to the aluminum of the battery case.

Embodiments of the present disclosure include a method of manufacturing a battery cell, comprising: forming an anode tab that extends from a sheet of a first material that forms an anode of a core of a cylindrical battery, wherein the anode tab is be electrically connected to a case of the cylindrical battery, wherein the battery case is made from aluminum, wherein the anode tab comprises is made from copper; moving the anode tab or the battery case such that the anode tab is in physical proximity to the battery case and abuts the battery case at a joint; moving tooling of a friction stir welder into contact with the joint; rotating the tooling to create friction at the joint, wherein the fiction creates heat that melts the copper and aluminum; mixing the melted copper and the melted aluminum at the joint; and creating a matrix of copper and aluminum that fuses the anode tab to the battery case.

Any of the one or more above aspects, wherein, wherein the tooling moves along at least a portion of the length of joint to fuse the anode tab to the battery case.

Any of the one or more above aspects, wherein, wherein the matrix of copper and aluminum prevents corrosion or oxidation at the joint.

Any of the one or more above aspects, wherein, wherein the joint is at a side of the battery case.

Any of the one or more above aspects, wherein, further comprising spot welding a cathode tab extending from a second sheet of a second material that forms a cathode of the core of the cylindrical battery to a top portion of the cylindrical battery.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A battery, comprising:
a battery core including a lamination, the lamination comprising:
an anode formed from a first sheet of a first material;
a cathode formed from a second sheet of a second material;
a first tab extending from the first sheet of material;
a second tab extending from the second sheet of material;
a top portion; and
a case, wherein the case is made from aluminum.

2. The battery of claim 1, wherein the first tab is made from copper.

3. The battery of claim 2, wherein the second tab is made from aluminum.

4. The battery of claim 3, wherein the first tab is plated in a non-corrosive material.

5. The battery of claim 4, wherein the non-corrosive material is nickel.

6. The battery of claim 5, wherein the plated first tab is spot welded to the case.

7. The battery of claim 3, wherein the first tab is spot welded to the top portion.

8. The battery of claim 7, wherein the top portion is a negative terminal of the battery.

9. The battery of claim 3, wherein the copper of the first tab is mixed with the aluminum of the to the case.

10. The battery of claim 9, wherein the copper of the first tab is mixed with the aluminum of the to the case by a friction stir weld.

11. A welding method, comprising:
providing an anode tab extending from an anode of a core of a cylindrical battery, wherein the anode tab is to be spot welded to a case of the cylindrical battery, wherein the battery case is made from aluminum, wherein the anode tab comprises a first material, wherein the first material is copper;
plating the anode tab with a second material, wherein the second material is non-corrosive;
providing the core comprising the anode tab;
moving the anode tab or the battery case such that the anode tab is in physical proximity to the battery case; and
when the anode tab is within physical proximity of the battery case, spot welding the anode tab to the battery case.

12. The welding method of claim 11, wherein the second material coats the first material by hot dipping the first material into a molten second material.

13. The welding method of claim 11, wherein the second material is joined to the first material by welding, brazing, hot dipping, and/or adhering.

14. The welding method of claim 11, wherein the second material is nickel.

15. The welding method of claim 11, wherein the second material is not corrosive to the aluminum of the battery case.

16. A method of manufacturing a battery cell, comprising:
forming an anode tab that extends from a sheet of a first material that forms an anode of a core of a cylindrical battery, wherein the anode tab is be electrically connected to a case of the cylindrical battery, wherein the battery case is made from aluminum, wherein the anode tab comprises is made from copper;
moving the anode tab or the battery case such that the anode tab is in physical proximity to the battery case and abuts the battery case at a joint;
moving tooling of a friction stir welder into contact with the joint;
rotating the tooling to create friction at the joint, wherein the fiction creates heat that melts the copper and aluminum;
mixing the melted copper and the melted aluminum at the joint; and
creating a matrix of copper and aluminum that fuses the anode tab to the battery case.

17. The method of manufacturing of claim 17, wherein the tooling moves along at least a portion of the length of joint to fuse the anode tab to the battery case.

18. The method of manufacturing of claim 17, wherein the matrix of copper and aluminum prevents corrosion or oxidation at the joint.

19. The method of manufacturing of claim 17, wherein the joint is at a side of the battery case.

20. The method of manufacturing of claim 17, further comprising spot welding a cathode tab extending from a second sheet of a second material that forms a cathode of the core of the cylindrical battery to a top portion of the cylindrical battery.
